(19) United States
(12) Patent Application Publication
(10) Pub. No.: US 2008/0136643 A1
(43) Pub. Date: Jun. 12, 2008

(54) APPARATUS FOR MANAGING POWER IN PASSIVE TAG AND METHOD THEREOF

(75) Inventors: Junho YEO, Daegu-City (KR); Josef PRIESHUB-PFLURGL, Klagenfurt (AT); Alex JANEK, Klagenfurt (AT); Andreas SCHUHA, Klagenfurt (AT); Hae- Won SON, Daejeon-city (KR); Jae- Young JUNG, Daejeong-city (KR); Hee- Sook MO, Daejeon-city (KR); Ji- Hoon BAE, Daejeon-city (KR); Gil- Young CHOI, Daejeon-city (KR); Cheol- Sig PYO, Daejeon-city (KR); Jong- Suk CHAE, Daejeon-city (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTITUTE, Daejeon-city (KR)

(21) Appl. No.: 11/931,062

(22) Filed: Oct. 31, 2007

(30) Foreign Application Priority Data
Dec. 8, 2006 (KR) 10-2006-0125031

(51) Int. Cl. G08B 13/14

(52) U.S. Cl. 340/572.2

(57) ABSTRACT

According to the present invention, the apparatus receives a radio frequency (RF) signal transmitted from the Radio Frequency Identification (RFID) reader, measures the strength of the received RF signal, and controls the power supplied from the power supply unit included in the tag or the power excited by the RF signal to be supplied to the tag according to whether the power excited by the received RF signal exceeds a level necessary to operate the tag based on the measured strength of the RF signal. Thus, efficiency of power consumption of the tag and the RFID transmission/reception system can be maximized and the amount of data is reduced to the extent that the set of commands is not needed, thereby simplifying a data process.

### CROSS-REFERENCE TO RELATED PATENT APPLICATION

This application claims the benefit of Korean Patent Application No. 10-2006-0125031, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a battery or power that is managed in a passive tag, and more particularly, to power management which maximizes an efficiency of power consumption of a tag and a Radio Frequency Identification (RFID) transmission/reception system by consuming power of the battery included therein when the strength of the RF power transmitted from a reader is determined and the amount of the RF power is not sufficient to operate the tag.

The present invention is derived from the research performed as a part of the information technology (IT) new growth power core technology development business, which was hosted by the Ministry of Information and Communications Republic of Korea (MIC) and the Institute for Information Technology Advancement (IITA) [Task management No.: 2005-S-106-02, entitled “Development of Sensor Tag and Sensor Node Technologies for RFID/USN”].

2. Description of the Related Art

A Radio Frequency Identification (RFID) is a process or chip which puts information about processes of producing, distributing, storing, and selling products into a tag attached to the products, has its own antenna, makes a RFID reader read the information, and connects with an artificial satellite or uses mobile communication in order to access an information system.

Meanwhile, a RFID system includes a tag and a reader, wherein the tag stores information and exchanges data according to a protocol and the reader communicates with the tag.

The RFID tag can be classified into an active type and a passive type, wherein the active type needs a power source and uses a direct power supply, and the passive type is operated by an electromagnetic field of the reader without power being supplied directly from inside or outside of the RFID tag. By using the active type, required power for the reader is reduced and an identification distance may be far from the reader. However, since a power supply device is needed, the operation time is limited and the cost of the active type is more expensive than the passive type. On the other hand, the passive type is lighter than the active type, the cost of the passive type is less than the active type, and the passive type can be used semi-permanently. However, when the passive type is used, an identification distance is short and more power is consumed by the reader, compared to when the active type is used.

In addition, a battery powered passive tag, which combines the active type and the passive type, has been suggested.

However, according to the conventional battery powered passive tag, whether to operate the battery included therein is determined by the reader. Accordingly, the reader should transmit data including a separate set of commands indicating whether to operate the battery to the tag and the tag also should process the separate set of commands. Therefore, the reader and the tag consume more power in order to process the set of commands, thus causing various problems such as reduction of identification distance, shortening of the life of the battery included in the tag, and complication of transmitted/sent data.

### SUMMARY OF THE INVENTION

The present invention provides an apparatus for managing power in a passive tag and a method thereof, in which power of a battery included therein is consumed when an amount of the power transmitted from a reader is not sufficient to operate a tag.

According to an aspect of the present invention, there is provided an apparatus for managing power in a passive tag which communicates with a Radio Frequency Identification (RFID) reader according to an RF signal transmitted from the RFID reader, the apparatus including: a power supply unit which supplies an operating power of the tag according to a predetermined control; a power reception unit which receives the RF signal transmitted from the RFID reader; a power management unit which measures a strength of the RF signal received from the power reception unit and supplies a power excited by the RF signal or the operating power of the tag from the power supply unit according to control based on a result of the measuring; and a control unit which controls the power management unit so that the power excited by the RF signal according to the strength of the RF signal measured by the power management unit or the power from the power supply unit is supplied to the tag.

The power management unit may measure a voltage level of the received RF signal so as to measure the strength of the RF signal. When it is determined that the power to be excited by the RF signal based on the strength of the RF signal exceeds a fixed level necessary to operate the tag, the control unit may control the power excited by the RF signal only to be supplied to the tag.

According to another aspect of the present invention, there is provided method of managing power in a passive tag which communicates with an RFID reader according to an RF signal transmitted from the RFID reader, the method including: receiving the RF signal transmitted from the RFID reader; measuring a strength of the received RF signal; and controlling a power supplied from a power supply unit included in the tag or a power excited by the RF signal to be supplied to the tag according to whether the power excited by the received RF signal exceeds a level necessary to operate the tag based on the measured strength of the RF signal.

In measuring the strength of the received RF signal, a voltage level of the RF signal may be measured so as to measure the strength of the RF signal. In controlling the power excited by the RF signal to be supplied to the tag, when it is determined that the power to be excited by the RF signal based on the strength of the RF signal exceeds a fixed level necessary to operate the tag, only the power excited by the RF signal may be controlled to be supplied to the tag.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for managing power in a passive tag according to an embodiment of the present invention; and

FIG. 2 is a block diagram of a tag including an apparatus for managing power in a passive tag according to an embodiment of the present invention.

### DETAILED DESCRIPTION OF THE INVENTION

Hereinafter, the present invention will be described more fully with reference to the accompanying drawings, in which exemplary embodiments of the invention are shown.

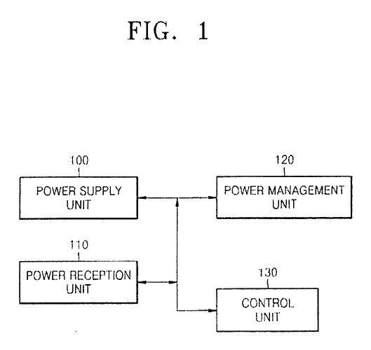

FIG. 1 is a block diagram of an apparatus for managing power in a passive tag according to an embodiment of the present invention.

The apparatus manages power in the tag which communicates with a Radio Frequency Identification (RFID) reader according to an RF signal transmitted from the RFID reader. The apparatus includes a power supply unit 100, a power reception unit 110, a power management unit 120, and a control unit 130. The power supply unit 100 supplies the operating power of the tag according to a predetermined control strategy. The power reception unit 110 receives the RF signal transmitted from the RFID reader. The power management unit 120 measures the strength of the RF signal received from the power reception unit 110 and supplies the power excited by the RF signal or the power to operate the tag from the power supply unit 100 according to the control of the measurement result. The control unit 130 controls the power management unit 120 so that the power excited by the RF signal according to the strength of the RF signal measured by the power management unit 120 or the power from the power supply unit 100 is supplied to the tag.

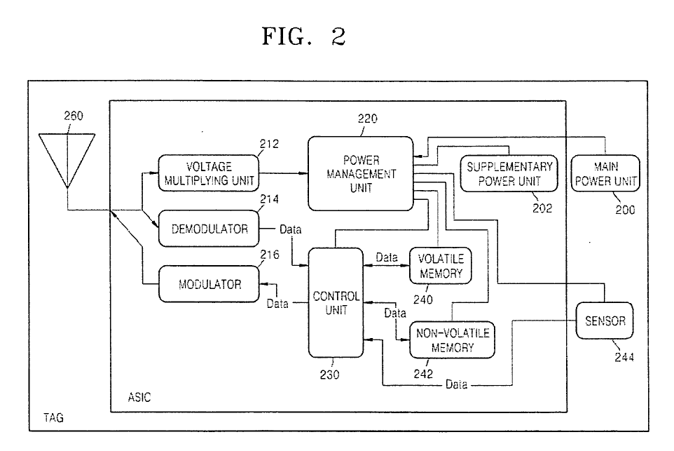

In FIG. 1, a memory included in the tag, a sensor, a modulator and a demodulator are not illustrated. Also, a specific part of FIG. 1 can be substantially embodied to be included in a device such as an application specific integrated circuit (ASIC) and thus the elements of the apparatus according to the present invention are divided into TAG and ASIC in FIG. 2.

The apparatus receives the RF signal transmitted from the RFID reader, measures the strength of the received RF signal, and controls the power supplied from the power supply unit 100 included in the tag or the power excited by the RF signal to be supplied to the tag according to whether the power excited by the received RF signal exceeds a level necessary to operate the tag based on the measured strength of the RF signal. Such processes will be described below.

FIG. 2 is a block diagram of a tag including an apparatus for managing power in a passive tag according to an embodiment of the present invention.

The tag of FIG. 2 includes an antenna 210, a voltage multiplying unit 212, a demodulator 214, a modulator 216, a power management unit 220, a main power unit (battery) 200, a supplementary power unit (Sustain Capacitor) 202, a volatile memory (VM) 240, a non-volatile memory (NVM) 242, a sensor 244, and a control unit (central logic) 230.

Comparing FIG. 1 and FIG. 2, the power supply unit 100 of FIG. 1 corresponds to the main power unit (battery) 200 and the supplementary power unit (sustain capacitor) 202 of FIG. 2, the power reception unit 110 of FIG. 1 corresponds to the antenna 210 and the voltage multiplying unit 212 of FIG. 2, the power management unit 120 of FIG. 1 corresponds to the power management unit 220 of FIG. 2, and the control unit 130 of FIG. 1 corresponds to the control unit (central logic) 230 of FIG. 2.

The voltage multiplying unit 212 generates a DC voltage from the analog RF signal received through the antenna 210 and outputs the DC voltage to the power management unit 220.

The demodulator 214 demodulates data received through the antenna 210 and outputs the demodulated data to the control unit 230. The modulator 216 modulates data input from the control unit 230 and transmits the modulated data to the RFID reader through the antenna 210.

The power management unit 220 measures the strength of the power of the RF signal input from the voltage multiplying unit 212 and outputs ‘strength information’ of the corresponding signal to the control unit 230. Also, the power management unit 220 supplies the RF power excited by the RF signal transmitted from the RFID reader or the power of the main power unit 200 to elements that need a power supply from the tag, that is, the VM 240, the NVM 242, the sensor 244, the supplementary power unit, and the control unit 230, based on the signal input from the control unit 230 in correspondence to the strength information.

Moreover, the power management unit 220 measures a remaining amount of power of the main power unit 200 and corresponding ‘remaining information’ is output to the control unit 230.

When it is determined from the strength information input from the power management unit 220 that the RF power is sufficient as the power used to operate the tag, the control unit 230 controls the power management unit 220 so as to accomplish the power supply according to a predetermined method, for example, a backscatter coupling method. In addition, when the RF power is not sufficient, the control unit 230 controls the power management unit 220 so that the power stored in the main power unit 200 is used.

In addition, when it is determined from the remaining information input from the power management unit 220 that insufficient power remains in the battery which is the main power unit 240, the control unit 230 controls the modulator 216 so that a signal indicating that no power remains in the main power unit 220 is transmitted to the RFID reader by using the RF power transmitted from the reader.

In addition to this, in the apparatus for managing power according to the present invention, the RF signal received from the RFID reader can be used in various ways as described below.

In other words, in the apparatus for managing power, a first received command of the RF signal received from the RFID reader can be used to measure the strength of the RF signal and a second received command of the RF signal can be used to communicate with the RFID reader.

Also, the first received command of the RF signal received from the RFID reader can be used to measure the strength of the RF signal and to communicate with the RFID reader.

In addition, an unmodulated carrier of the RF signal received from the RFID reader can be used to measure the strength of the RF signal and to communicate with the RFID reader.

Moreover, a non-communication protocol carrier of the RF signal received from the RFID reader can be used to measure the strength of the RF signal and the first received command can be used to communicate with the RFID reader.

Such operations can be performed by controlling the power management unit 220, the demodulator 214, and the modulator 216 with reference to techniques of the present invention.

According to the present invention, the apparatus receives the RF signal transmitted from the RFID reader, measures the strength of the received RF signal, and controls the power supplied from the power supply unit included in the tag or the power excited by the RF signal to be supplied to the tag according to whether the power excited by the received RF signal exceeds a level necessary to operate the tag based on the measured strength of the RF signal. Thus, efficiency of power consumption of the tag and the RFID transmission/reception system can be maximized and the amount of data is reduced to the extent that the set of commands is not needed, thereby simplifying a data process.

In addition, it is obvious to one of ordinary skill in the art that each process can be embodied in various ways with software or hardware by using a general programming method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for managing power in a passive tag which communicates with a Radio Frequency Identification (RFID) reader according to an RF signal transmitted from the RFID reader, the apparatus comprising:
a power supply unit which supplies an operating power of the tag according to a predetermined control;
a power reception unit which receives the RF signal transmitted from the RFID reader;
a power management unit which measures a strength of the RF signal received from the power reception unit and supplies a power excited by the RF signal or the operating power of the tag from the power supply unit according to control based on a result of the measuring; and
a control unit which controls the power management unit so that the power excited by the RF signal according to the strength of the RF signal measured by the power management unit or the power from the power supply unit is supplied to the tag.

2. The apparatus of claim 1, wherein the power management unit measures a voltage level of the received RF signal so as to measure the strength of the RF signal.

3. The apparatus of claim 1, wherein when it is determined that the power to be excited by the RF signal based on the strength of the RF signal exceeds a fixed level necessary to operate the tag, the control unit controls the power excited by the RF signal only to be supplied to the tag.

4. The apparatus of claim 1, wherein in the RF signal received from the RFID reader, a first received command is used to measure the strength of the RF signal and a second received command is used to communicate with the RFID reader.

5. The apparatus of claim 1, wherein the first received command of the RF signal received from the RFID reader is used to measure the strength of the RF signal and to communicate with the RFID reader.

6. The apparatus of claim 1, wherein in the RF signal received from the RFID reader, an unmodulated carrier is used to measure the strength of the RF signal and the first received command is used to communicate with the RFID reader.

7. The apparatus of claim 1, wherein in the RF signal received from the RFID reader, a non-communication protocol carrier is used to measure the strength of the RF signal and the first received command is used to communicate with the RFID reader.

8. The apparatus of claim 1, wherein the tag is operated in order to communicate with the RFID reader.

9. A method of managing power in a passive tag which communicates with an RFID reader according to an RF signal transmitted from the RFID reader, the method comprising:
receiving the RF signal transmitted from the RFID reader;
measuring a strength of the received RF signal; and
controlling a power supplied from a power supply unit included in the tag or a power excited by the RF signal to be supplied to the tag according to whether the power excited by the received RF signal exceeds a level necessary to operate the tag based on the measured strength of the RF signal.

10. The method of claim 9, wherein in measuring the strength of the received RF signal, a voltage level of the RF signal is measured so as to measure the strength of the RF signal.

11. The method of claim 9, wherein in controlling the power excited by the RF signal to be supplied to the tag, when it is determined that the power to be excited by the RF signal based on the strength of the RF signal exceeds a fixed level necessary to operate the tag, only the power excited by the RF signal is controlled to be supplied to the tag.

12. The method of claim 9, wherein in the RF signal received from the RFID reader, a first received command is used to measure the strength of the RF signal and a second received command is used to communicate with the RFID reader.

13. The method of claim 9, wherein the first received command of the RF signal received from the RFID reader is used to measure the strength of the RF signal and to communicate with the RFID reader.

14. The method of claim 9, wherein in the RF signal received from the RFID reader, an unmodulated carrier is used to measure the strength of the RF signal and the first received command is used to communicate with the RFID reader.

15. The method of claim 9, wherein in the RF signal received from the RFID reader, a non-communication protocol carrier is used to measure the strength of the RF signal and the first received command is used to communicate with the RFID reader.

16. The method of claim 9, wherein the tag is operated in order to communicate with the RFID reader.
